(19) United States
(12) Patent Application Publication
(10) Pub. No.: US 2004/0124725 A1
(43) Pub. Date: Jul. 1, 2004

(54) Cooling fan motor for condenser having direct engagement type connector with choke coil therein

(75) Inventor: Jae-Yong Shin, Yoosung-Gu (KR)

Correspondence Address: R. Neil Sudol, 714 Colorado Avenue, Bridgeport, CT, 06605-1601, US

(73) Assignee: KAMCO CO., LTD., Cheongwon-Gun (KR)

(21) Appl. No.: 10/351,972

(22) Filed: Jan. 27, 2003

(30) Foreign Application Priority Data
Dec. 26, 2002 (KR) 2002-83875

(51) Int. Cl. H02K 11/00

(52) U.S. Cl. 310/71

(57) ABSTRACT

The present invention relates to a condenser motor having a direct engagement type connector with a choke coil therein which comprises an end cover in which an engaging protrusion having a plurality of pin engaging holes is protruded, a connector in which a connector leg having an engaging member engaged with an engaging protrusion of the end cover is formed, and an engaging terminal is formed in an upper portion of the connector leg for thereby being engaged with a wire harness, a plurality of pins in which an end of each of the same is protruded in an inner direction of the engaging terminal of the connector for applying a power inputted, and the other end of each of the same is protruded from an upper surface of the engaging member of the connector leg, and an intermediate portion of each of the same is embedded in the connector leg, and a choke coil which is embedded in the connector leg for thereby being connected with a plurality of the pins for thereby preventing an electromagnetic wave which occurs when the motor is driven. In the present invention, it is possible to implement an easier management of a lead line adapted for supplying a power for driving a motor. It is not needed to obtain a certain installation space for a choke coil in order for a motor to have a RFI function, so that a productivity is enhanced. In a case of a small motor which does not have an enough space, it is possible to implement a RFI function.

### BACKGROUND OF THE INVENTION

1. Field of the Invention

The present invention relates to a cooling fan motor for a condenser having a direct engagement type connector with a choke coil therein, and in particular to an improved cooling fan motor for a condenser having a direct engagement type connector with a choke coil therein which is capable of implementing an easier management of a lead line to which a power is applied for driving a motor by engaging a direct engagement type connector housing having a choke coil therein to an end cover having a bearing which is supported in such a manner that an end of an armature shaft of a cooling motor fan is rotated and minimizing a voltage drop in a lead line by decreasing the number of parts such as a cable, terminal, etc. for thereby enhancing a productivity of a motor based on the reduction of the number of parts and implementing an electromagnetic wave shielding function based on a built-in choke coil.

2. Description of the Background Art

Generally, in order to cool a coolant which flows through a condenser by rotating a cooling fan, there is provided a motor which is capable of rotating a cooling fan.

FIG. 1 is a view illustrating a conventional condenser cooling fan motor for cooling a coolant which flows through a condenser, by rotating a cooling fan.

The conventional condenser cooling fan motor includes a housing 10 having a through hole 10a through which a shaft passes and a first receiving unit 10b which receives a first bearing 30, an end cover 14 which is engaged opposite to the housing 10 through a flange 14a and includes a second receiving unit 14b for receiving a second bearing 32 therein, an armature shaft 20 which includes one end rotatably supported by the first bearing 30 in a state that the above one end is extended through a through hole 10a of the housing and the other end which is rotatably supported by the second bearing 32, an armature 22 which is inserted onto an outer circumference of the armature shaft 20, a rectifier 24 which is provided in the armature 22 and the end cover 14, and a brush 26 which is adapted to supply a power applied from a battery to the armature 22 through the rectifier 24 in a state that the brush 26 is elastically pressurized by a spring 28.

A mounting bracket 16 having an engaging hole 16a is attached to an outer side of the end cover 14.

A magnet 12 is attached to an inner side of the housing 10 in a portion opposite to the armature 22.

In the conventional condenser cooling fan motor, when a power which is applied to the rectifier 25 through the brush 26 is supplied to the armature 22 through a wire 38, a certain rotational force occurs by a magnetic force of the magnet 12 for thereby rotating the armature shaft 20. At this time, since a cooling fan is fixed to the fan engaging portion 20a formed in an end of the armature shaft 20, the cooling fan is rotated at a high speed by a strong rotational force of the armature shaft 20, so that the coolant which flows through the condenser is cooled.

When assembling the cooling fan motor, in a state that the end cover 14 is fixed to a jig, a second bearing 32 is inserted into the second receiving unit 14b, and then an end of the armature shaft 20 in which the rectifier 24 and the armature 22 are engaged is inserted into the second bearing 32. The second bearing 32 is inserted into the other end of the same, and the housing 10 is engage using a jig for thereby completing an assembling operation.

At this time, since the armature shaft 20 is rotatably engaged using the first bearing 30 and the second bearing 32, an air gap may be formed. In the assembling line, a certain washer 34, 36 having the same size as the above air gap is inserted for thereby preventing any movement in the longitudinal direction of the armature shaft 20.

An end of the cable 44 including the lead line 42 which is adapted to apply a power to the cooling fan motor is connected with the brush 26 formed in the interior of the same through the terminal of the end cover 14 from the outside of the motor, and the other end of the same is connected with the connector 40 which is engaged to a wire harness(not shown) capable of applying a power from the battery.

However, in the thusly constituted conventional condenser cooling fan motor, since the lead line which is externally extended is connected with the terminal connected with the brush based on a certain process from the fabrication step of the motor for supplying a power to the motor, the number of the processes is increased due to the fabrication process of the motor. Therefore, the assembling nature of the motor is decreased.

In addition, the management of the lead line connected to the brush through the terminal is complicated, and the other end of the lead line extended from the rear side of the motor is connected to the connector to which the wire harness is engaged for thereby causing much inconvenience. Since there is lead line between the connector and the motor, since the power inputted through the connector is decreased because the power must flow through the lead line.

These days, the demand for the restriction of EMI(Electric Magnetic Interference) is increased. Therefore, a choke coil is preferably installed in all kinds of motors for implementing the function of the electromagnetic wave shielding(RFI), so that a high frequency which occurs in the motor by the choke coil is prevented.

However, in the conventional art, almost motors are formed in the built-in type motor in which the choke coil is installed, so that the choke coil is not stable in its operation. In order to install the choke coil in the housing the motor, a certain installation space is needed in the motor. In the case of the motors which are recently fabricated, there is much difficulties for obtaining a certain space for the choke coil after necessary parts are first installed. Therefore, the assembling nature of the motor is significantly decreased in the conventional art.

### SUMMARY OF THE INVENTION

Accordingly, it is an object of the present invention to provide a cooling fan motor for a condenser having a direct engagement type connector which overcomes the problems encountered in the conventional art.

It is another object of the present invention to provide a cooling fan motor for a condenser having a direct engagement type connector with a choke coil therein which is capable of implementing an easier management of a lead line to which a power is applied for driving a motor by engaging a direct engagement type connector housing to an end cover having a bearing which is supported in such a manner that an end of an armature shaft of a cooling motor fan is rotated and minimizing a voltage drop in a lead line by decreasing the number of parts such as a cable, terminal, etc. for thereby enhancing a productivity of a motor based on the reduction of the number of parts.

It is still another object of the present invention to provide a cooling fan motor for a condenser having a direct engagement type connector with a choke coil therein which is capable of obtaining an electromagnetic wave shielding(RFI) function by installing a choke coil in the interior of a direct engagement type connector.

In order to achieve the above objects, in a condenser cooling fan motor, there is provided a condenser motor having a direct engagement type connector with a choke coil therein which includes an end cover in which an engaging protrusion having a plurality of pin engaging holes is protruded;

a connector in which a connector leg having an engaging member engaged with an engaging protrusion of the end cover is formed, and an engaging terminal is formed in an upper portion of the connector leg for thereby being engaged with a wire harness;

a plurality of pins in which an end of each of the same is protruded in an inner direction of the engaging terminal of the connector for applying a power inputted, and the other end of each of the same is protruded from an upper surface of the engaging member of the connector leg, and an intermediate portion of each of the same is embedded in the connector leg; and

a choke coil which is embedded in the connector leg for thereby being connected with a plurality of the pins for thereby preventing an electromagnetic wave which occurs when the motor is driven.

### BRIEF DESCRIPTION OF THE DRAWINGS

The present invention will become better understood with reference to the accompanying drawings which are given only by way of illustration and thus are not limitative of the present invention, wherein;

FIG. 1 is a cross-sectional view illustrating the whole construction of a conventional cooling fan motor for a condenser;

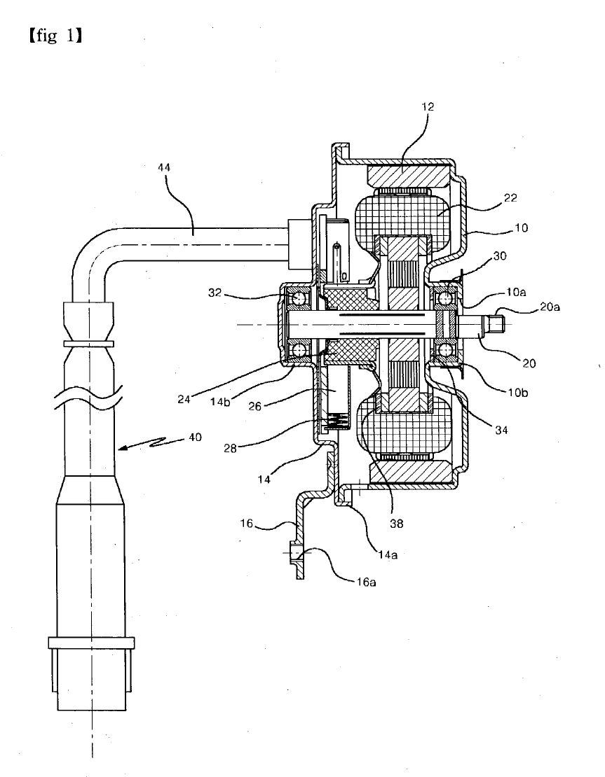

FIG. 2 is a cross-sectional view illustrating the whole construction of a cooling fan motor for a condenser having a direct engagement connector with a choke coil therein according to the present invention;

FIG. 3 is a perspective view illustrating a direct engagement type connector with a choke coil therein of FIG. 2 according to the present invention; and

FIG. 4 is a rear view illustrating an engaged state of a cooling fan motor for a condenser having a direct engagement type connector with a choke coil therein according to the present invention.

### DESCRIPTION OF MAJOR ELEMENTS OF THE DRAWINGS

50: housing

50a: first receiving unit

52: magnet

54: end cover

54a: second receiving unit

56: mounting bracket

60: armature shaft

62: armature

64: rectifier

66: brush

68: spring

70, 72: bearing

76: retainer

80: core

82, 83: spacer

90: direct engagement type connector

92: engaging member

94: engaging terminal

96: pin

98: connector leg

98a: reinforcing unit

99: choke coil

540: engaging protrusion

542: engaging hole

### DETAILED DESCRIPTION OF THE PREFERRED EMBODIMENTS

The preferred embodiments of the present invention will be described with reference to the accompanying drawings.

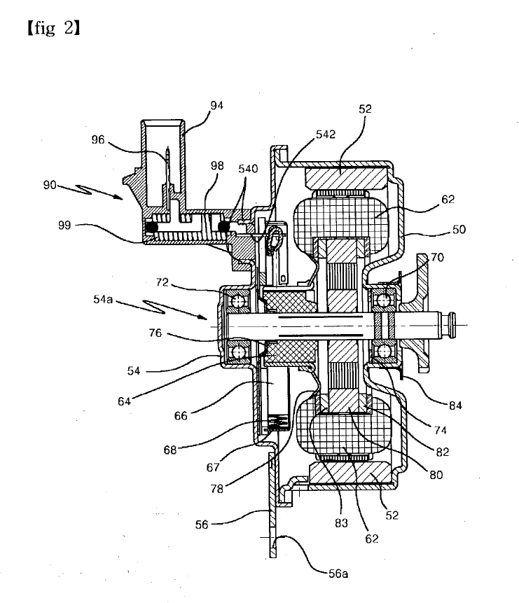

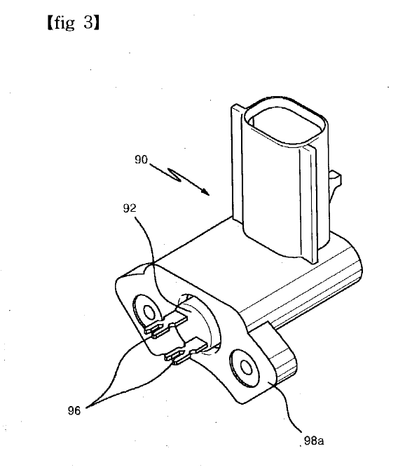

FIG. 2 is a cross-sectional view illustrating the whole construction of a cooling fan motor for a condenser having a direct engagement connector with a choke coil therein according to the present invention, and FIG. 3 is a perspective view illustrating a direct engagement type connector for a cooling fan motor for a condenser according to the present invention.

As shown in FIG. 2, the whole construction of the cooling fan motor for a condenser having a direct engagement type connector with a choke coil therein according to the present invention will be described. The cooling fan motor for a condenser having a direct engagement type connector according to the present invention includes a housing 50 having a magnet 52 attached in an inner surface of the same, an end cover 54 which is engaged opposite to the housing 50, an armature shaft 60 which has an armature in an outer circumference and is rotatably supported in the housing 50 in which a cooling fan is fixed to the fan engaging portion 60a, a rectifier 64 which is provided between the armature 62 and the end cover 54, and a brush 66 which is adapted to supply the power from the battery to the armature 62 through the rectifier 64 in a state that the same is elastically pressurized by the spring 68.

In addition, the mounting bracket 56 in which an engaging hole 56a is formed is attached to an outer surface of the end cover 54. The housing 50 and the end cover 54 are engaged each other in opposite direction through the flange portion(not shown) in the same manner as the conventional art. In addition, the spacers 82, 83 is inserted in both sides of the core 80 in the interior of the armature 62.

An end of the armature shaft 60 is rotatably engaged with respect to the housing 50 by the first bearing which is a ball bearing 70 of a seal type, and the other end of the same is rotatably enraged with respect to the end cover 54 by the second bearing. Here, a water guide 84 is attached to an outer end portion of the first receiving unit 50a in which the first bearing is received.

The second bearing which is received in the second receiving unit 54a of the end cover 54 for thereby rotatably supporting the armature shaft 60 may be selected between a seal type ball bearing 72 or a sintered type bearing.

A gap adjusting washer 74 is inserted into the armature shaft 60 installed near the ball bearing 70, and a retainer 76 is provided between the end cover 54 and the rectifier 64.

Therefore, as an air conditioner is operated, when the power applied to the rectifier 65 through the brush 66 is supplied to the armature 62, a certain force is generated based on a magnetic force of the magnet 52 for thereby rotating the armature shaft 60. At this time, since a cooling fan is fixed to the fan engaging unit 60a formed in an end portion of the armature shaft 60, the cooling fan is rotated at a high speed based on a strong rotational force of the armature shaft 60 for to thereby cooling a coolant which flows in the condenser.

The present invention is basically directed to supplying a power to the interior of a motor using a 2-pin direct engagement type connector. In addition, the direct engagement connector includes a choke coil. The connector connected with a wire harness capable of receiving a power from a battery and applying the power to the motor is formed based on a pin type direct engagement method. Therefore, it is possible to supply power in such a manner that the connector is directly connected to the motor without an additional lead line. In addition, it is possible to implement an electromagnetic wave shielding(RFI) function based on the built-in choke coil.

As shown in FIG. 2, an engaging protrusion 540 is protruded from one side of a back surface of the end cover 54. A 2-pin type direct engagement type connector 90 is engaged to the engaging protrusion 540.

Here, a plurality of engaging holes 542 communicating with the brush 66 in the motor are formed in the inner side of the engaging protrusion 540.

FIG. 3 is a perspective view illustrating a 2-pin type direct engagement type connector according to the present invention. In the above 2-pin type direct engagement type connector 90, an engaging terminal 94 is formed in an upper portion of the same for thereby implementing an engagement with a wire harness. A connector leg 98 is integrally formed in a lower portion of the engaging terminal 94.

A pair of pins 96 are embedded in the interior of the connector leg 98 in such a manner that an end of each of the pins 96 is inwardly protruded for thereby guiding a flow of alternating current inputted.

The other end of each of the pins 96 embedded in the connector leg 98 is outwardly protruded in the front direction of a pair of the engaging member 92 formed in one side surface of the connector leg 98 which is engaged in such a manner that the engaging protrusion 540 of the end cover 54 is inserted.

A coil shaped wound choke coil 99 is installed in the interior of the connector leg 98 for thereby being connected with the pins 96.

Therefore, when the 2-pin type direct engagement type connector having a choke coil therein is engaged to a back surface of the end cover of the motor, the engaging member 92 formed in one surface of the connector leg 98 is engaged to the engaging protrusion 540 protruded from the back surface of the end cover 54 for thereby implementing an engagement therebetween. Since a plurality of pins 96 protruded from the front surface of the engaging member 92 are connected with the brush 66 of the motor through the engaging hole 542, the power which is externally supplied is supplied to the brush 66 in the interior of the motor through the pins 96.

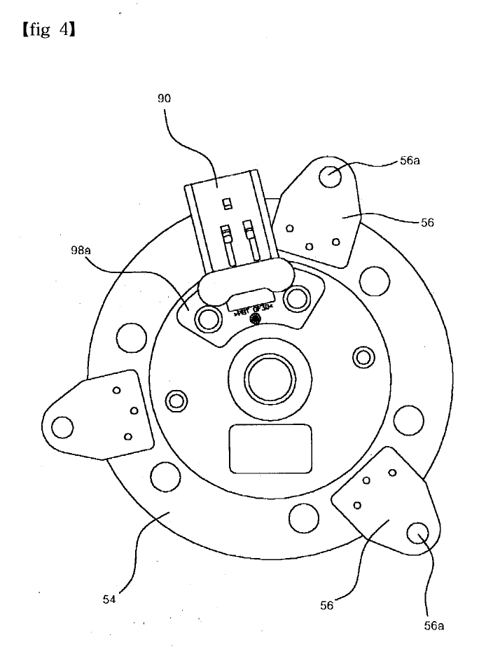

Here, as shown in FIG. 4, when the direct engagement connector 90 is engaged to the back surface of the end cover 54, a reinforcing portion 98a formed in both sides of the connector leg 98 is engaged with the end cover 54 of the motor using rivets.

The operation and effects of the present invention will be described with reference to the accompanying drawings.

As shown in FIGS. 2 through 4, when the direct engagement type connector 90 having a choke coil 99 therein is engaged to the back surface of the end cover 54 of the motor, the engaging member 92 formed in one surface of the connector leg 98 is engaged with the engaging protrusion 540 protruded from the back surface of the end cover 54 for thereby implementing an engagement therebetween. A plurality of the pins 96 protruded from the front surface of the engaging member 92 are connected with the brush 66 in the motor through the engaging hole 542, so that an externally supplied power is supplied to the brush 66 in the motor through the pins 96.

Here, the engaging terminal 94 of the connector 90 is connected with a wire harness(not shown) which is capable of supplying an external power from the battery, so that the external power from the battery is applied to the connector 90 through the wire harness. The power supplied to the connector is supplied to the brush 66 installed in the motor through a plurality of the pins 96 embedded in the connector 90, so that the armature shaft 60 is rotated for thereby driving the motor.

Namely, in the present invention, since the connector installed in the back surface of the motor for supplying the power is engaged based on a direct engagement method, it is possible to decrease the number of parts such as a cable, terminal, etc., and to decrease the fabrication cost.

In particular, since the choke coil 99 is installed in the interior of the connector 90, it is possible to effectively prevent an electromagnetic wave which occurs when the motor is driven.

As described above, according to the condenser motor having a direct engagement type connector with a choke coil therein, an external power is supplied to the cooling fan motor through the direct engagement type connector, so that the management of the lead line to which a power is applied for driving the motor is easy. In addition, it is possible to decrease the number of parts such as a cable, terminal, etc. and to minimize the voltage drop which occurs in the lead line.

In addition, in the present invention, it is not needed to obtain a certain installation space in the motor for the choke coil in order for the motor to have a RFI function for thereby enhancing a productivity of the motor. Furthermore, in the case of a small size motor which does not have an enough space, it is possible to implement a desired RFI function.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a condenser cooling fan motor, a condenser motor having a direct engagement type connector with a choke coil therein, comprising:
an end cover in which an engaging protrusion having a plurality of pin engaging holes is protruded;
a connector in which a connector leg having an engaging member engaged with an engaging protrusion of the end cover is formed, and an engaging terminal is formed in an upper portion of the connector leg for thereby being engaged with a wire harness;
a plurality of pins in which an end of each of the same is protruded in an inner direction of the engaging terminal of the connector for applying a power inputted, and the other end of each of the same is protruded from an upper surface of the engaging member of the connector leg, and an intermediate portion of each of the same is embedded in the connector leg; and
a choke coil which is embedded in the connector leg for thereby being connected with a plurality of the pins for thereby preventing an electromagnetic wave which occurs when the motor is driven.
